(19) United States
(12) Patent Application Publication
(10) Pub. No.: US 2019/0283086 A1
(43) Pub. Date: Sep. 19, 2019

(54) DOUBLE SIDED CONVEX MIRROR CLEANING TOOL

(71) Applicant: Shane Schindler, Daisytown, PA (US)

(72) Inventor: Shane Schindler, Daisytown, PA (US)

(21) Appl. No.: 16/042,748

(22) Filed: Jul. 23, 2018

Related U.S. Application Data
(60) Provisional application No. 62/644,341, filed on Mar. 16, 2018.

(51) Int. Cl. B08B 1/00; B60S 3/04

(52) U.S. Cl. CPC B08B 1/008; B60S 3/045; B08B 1/005

(57) ABSTRACT

The improved double-sided convex mirror cleaning tool disclosed herein may comprise, at least, a fixed, concave cleaning blade and a handle. Such a device contemplates the use of resilient and flexible materials for the cleaning blade suitable for use in cleaning windows, and resilient and solid materials suitable for structural rigidity in the device main body. The combination is unique in that the cleaning blade is a concave blade meant to contour most effectively with convex mirrors commonly found on tractor-trailer combinations. The device may further comprise a second, straight cleaning blade for use in the cleaning of planar mirrors, or may instead comprise a variety of attachments suitable for providing additional functionality to the device.

### TECHNICAL FIELD OF THE INVENTION

The present invention relates in general to handheld cleaning devices, and, more specifically, to an improved double-sided convex mirror cleaning tool.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

A squeegee is a tool with a smooth blade used to remove or control the flow of liquid on a surface. Such a tool used in window-cleaning is a hand-held device comprising, at least, a handle or handle receiver, a rubber blade receiver, and a rubber blade. A number of variations of squeegees have been developed, with some squeegees being backed by a sponge to scrub a window, or other squeegees having flexible blades to contour around non-planar surfaces.

A convex mirror is a mirror with an outwardly-bulged reflecting surface that provides a wider viewing surface at the expense of distorted distance perception. Such mirrors are commonly used in the automotive industry as passenger side mirrors or as blind-spot mirrors to provide a driver with a larger field of view. Such mirrors are also used in the construction industry as hallway safety mirrors to provide a field of view around blind-corners.

In the trucking industry, tractor units are generally equipped with a number of convex mirrors to provide a driver with views of the extensive blind-spots around a tractor-trailer combination. Such mirrors are crucial to trucking safety as they permit a driver to change lanes on a roadway, monitor the condition and location of the vehicle's tires and load, and maneuver the tractor-trailer combination in reverse. Keeping the viewing field of such mirrors clean, though, is inefficient with flat-bladed squeegees and ineffective with flexible-blade squeegees. A flat-bladed squeegee does not provide the contact area needed to effectively clean a convex mirror, as the rubber blade does not contact the entirety of the surface at once, and a flexible-blade squeegee does not allow a user to apply sufficient force to the convex surface to effectively clean fluids from the mirror.

Thus, there is a need in the art for an improved double-sided convex mirror cleaning tool that comprises a fixed, concave cleaning blade to apply sufficient force to a convex surface. It is to these ends that the present invention has been developed.

### BRIEF SUMMARY OF THE INVENTION

To minimize the limitations in the prior art, and to minimize other limitations that will be apparent upon reading and understanding the present specification, the present invention describes an improved double-sided convex mirror cleaning tool comprising, at least, a fixed, concave cleaning blade and a handle.

It is an objective of the present invention to provide an improved double-sided convex mirror cleaning tool that may comprise a resilient material.

It is another objective of the present invention to provide an improved double-sided convex mirror cleaning tool that may comprise a plurality of cleaning blades.

It is another objective of the present invention to provide an improved double-sided convex mirror cleaning tool that may comprise a plurality of curved cleaning blades.

It is another objective of the present invention to provide an improved double-sided convex mirror cleaning tool that may comprise a plurality of straight cleaning blades.

It is another objective of the present invention to provide an improved double-sided convex mirror cleaning tool that may comprise a plurality of materials of construction.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 illustrates an improved double-sided convex mirror cleaning tool from a front upper three-quarters perspective.

FIG. 2 illustrates an improved double-sided convex mirror cleaning tool from a rear upper three-quarters perspective.

FIG. 3 illustrates an improved double-sided convex mirror cleaning tool from a front lower three-quarters perspective.

FIG. 4 illustrates an improved double-sided convex mirror cleaning tool from a rear lower three-quarters perspective.

FIG. 5 illustrates an improved double-sided convex mirror cleaning tool from a top perspective.

FIG. 6 illustrates an improved double-sided convex mirror cleaning tool from a bottom perspective.

FIG. 7 illustrates an improved double-sided convex mirror cleaning tool from a front perspective.

FIG. 8 illustrates an improved double-sided convex mirror cleaning tool from a rear perspective.

FIG. 9 illustrates an improved double-sided convex mirror cleaning tool from a left side perspective.

FIG. 10 illustrates an improved double-sided convex mirror cleaning tool from a right side perspective.

### DETAILED DESCRIPTION OF THE INVENTION

Certain terminology is used in the following description for reference only and is not limiting. The words “front,” “rear,” “anterior,” “posterior,” “lateral,” “medial,” “upper,” “lower,” “outer,” “inner,” and “interior” refer to directions toward and away from, respectively, the geometric center of the invention, and designated parts thereof, in accordance with the present disclosure. Unless specifically set forth herein, the terms “a,” “an,” and “the” are not limited to one element, but instead should be read as meaning “at least one.” The terminology includes the words noted above, derivatives thereof, and words of similar import.

The present invention relates in general to handheld cleaning devices, and, more specifically, to an improved double-sided convex mirror cleaning tool, comprising, at least, a fixed, concave cleaning blade and a handle. As contemplated by the present invention, the handle provides a central attachment point for at least one blade-holding assembly.

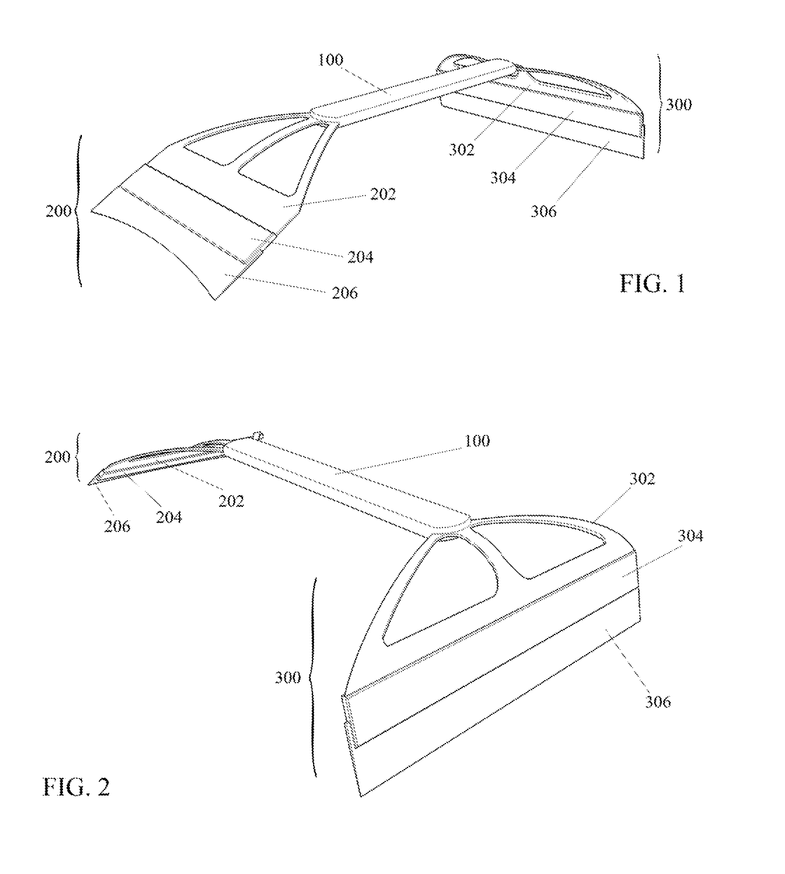

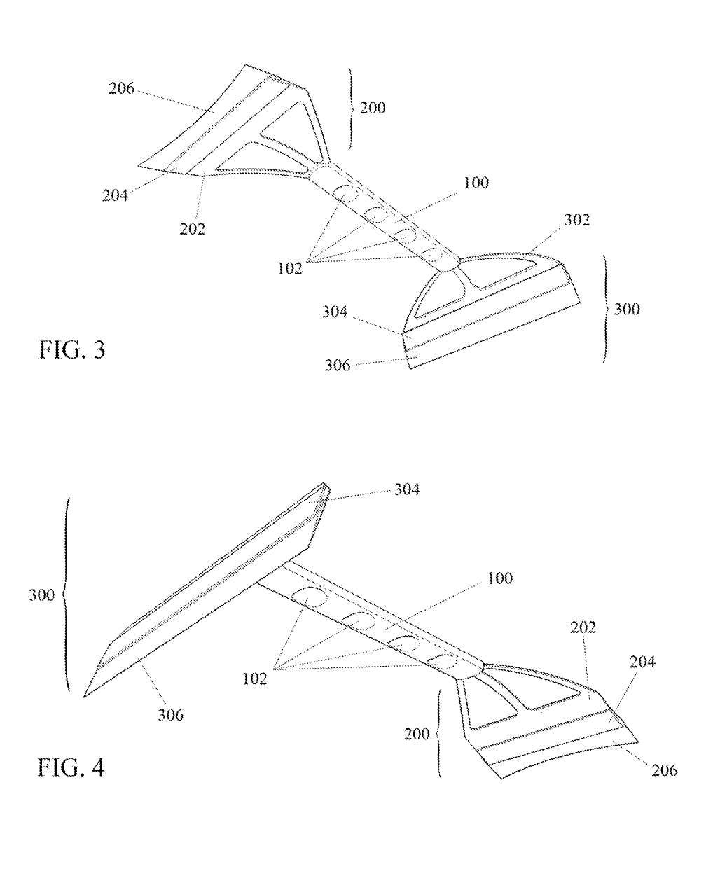

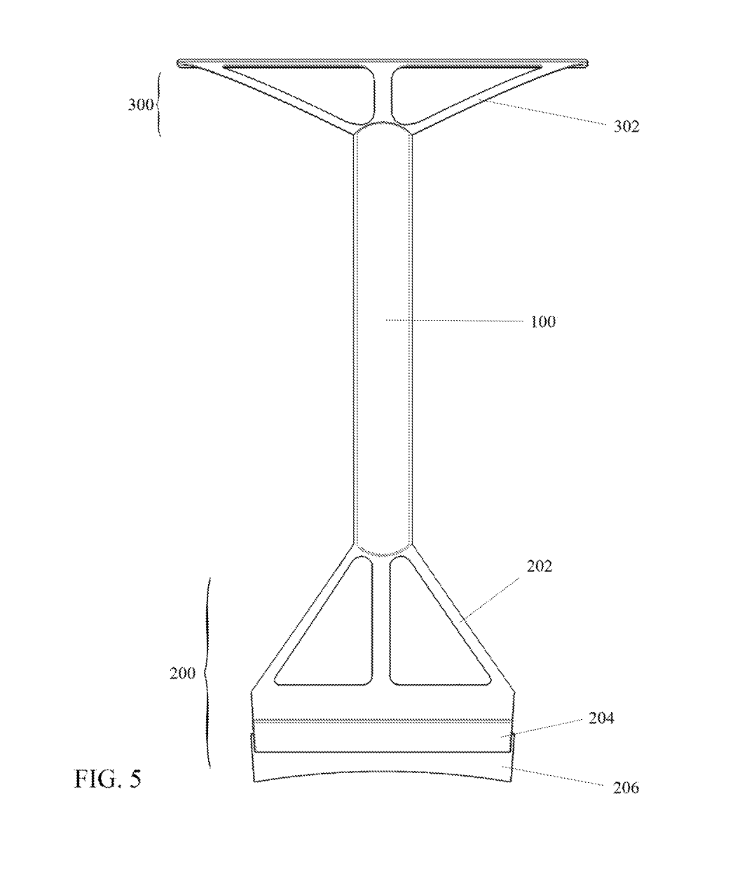

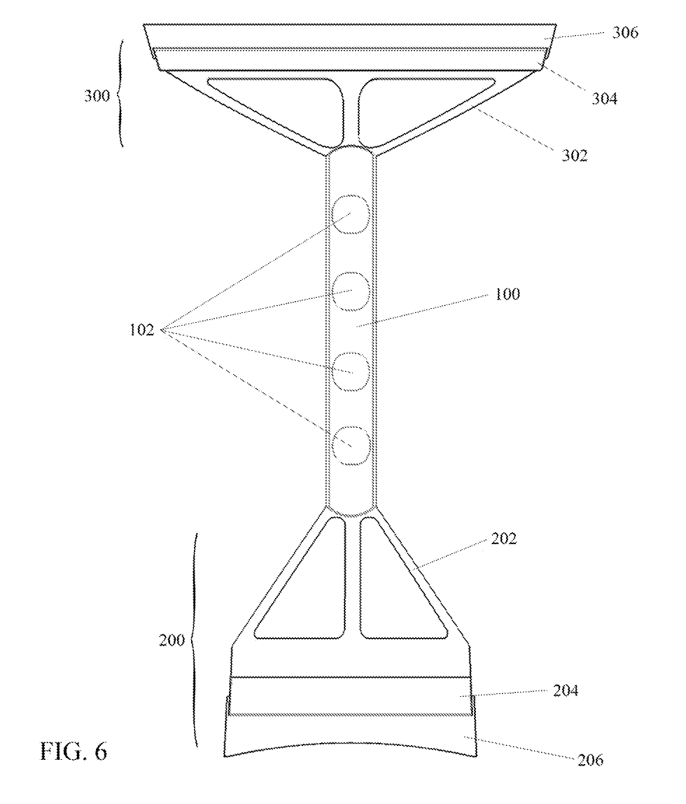

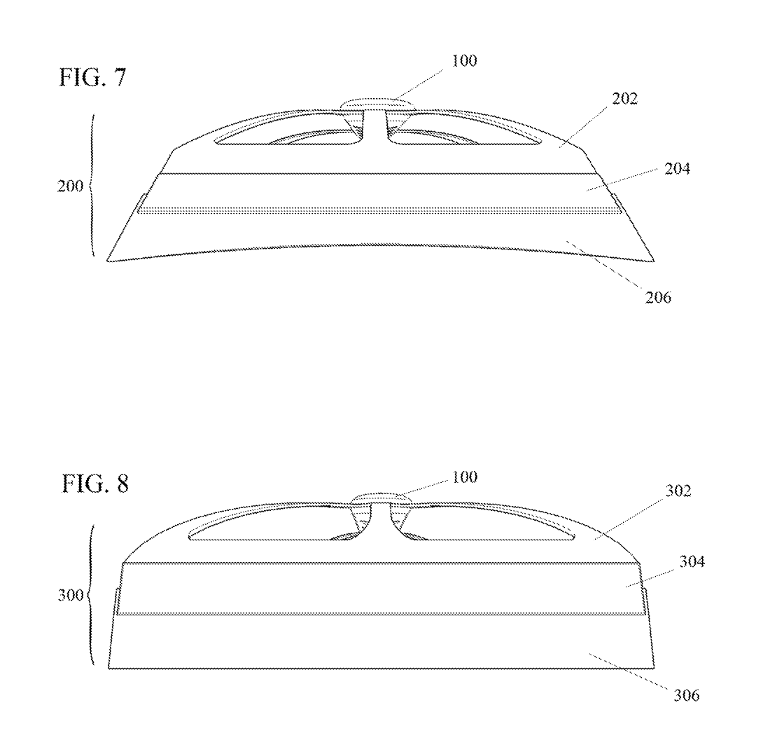

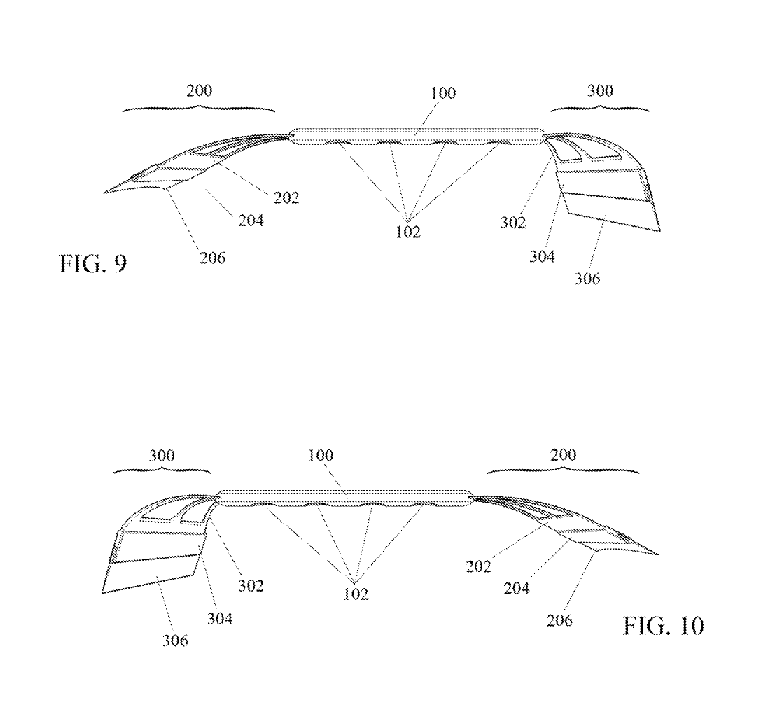

FIGS. 1 through 10 illustrate an improved double-sided convex mirror cleaning tool, comprising, at least, a fixed, concave cleaning blade and a handle as contemplated by the present invention. The figures identify a handle 100 and a plurality of finger grooves 102 as a central component of the device. The handle 100 may comprise any appropriate ergonomic shape, and in one embodiment is a length having a generally oval cross-section. The handle 100 further comprises an upper surface and a lower surface, and the plurality of finger grooves 102 may be located on the lower surface of the handle 100. The plurality of finger grooves 102 may comprise any appropriate ergonomic shape, and in one embodiment are round divots in the lower surface of the handle 100 evenly spaced along its length to permit comfortable holding by a user. The plurality of finger grooves 102 may further comprise raised textures or ridges to provide additional traction to a user of the device.

The handle 100 may be substantially constructed of any suitable solid or semi-solid materials, but typically is constructed of a resilient material or combination of materials such that the combination is resistant to compression, flexing, and crush damage as a result of everyday use. As an example, and without limiting the scope of the present invention, various exemplary embodiments of the device may be substantially constructed of one or more materials of plastic, wood, fiberglass, carbon fiber, aluminum, steel, or combinations thereof.

The figures further identify a curved blade assembly 200, which comprises a curved blade support 202, a curved blade receiver 204, and a curved blade 206. The curved blade support 202 further comprises a narrow end and a wide end. The handle 100 further comprises a first end and a second end, and the narrow end of the curved blade support 202 of the curved blade assembly 200 is attached to the first end of the handle 100. The curved blade support 202 may comprise any structural shape, and in one embodiment is a generally triangular shape having its narrow end nearest the handle 100. The triangular shape of the curved blade support 202 is advantageous in that it provides strength and bending resistance to the combination while also reducing weight, though is not the only advantageous shape that could be used.

The curved blade support 202 may further comprise a downward curve, which may be advantageous to the functioning of the device itself. The curving of the curved blade support 202 towards the lower aspect of the device may allow a user to apply sufficient pressure on the curved blade 206 against a convex surface by permitting an optimum angle to be achieved between the user's forearm and wrist, the handle 100, and the curved blade 206. The curving of the curved blade support 202 may be at any angle, or the curved blade support 202 may not be curved but may be planar or at a right angle.

The curved blade support 202 may further comprise cutouts or indentations for additional weight savings, though such weight savings are only advantageous so long as the structural rigidity of the device is maintained.

The curved blade receiver 204 further comprises a proximal end and a distal end, and is attached at its proximal end to the wide end of the curved blade support 202. The curved blade receiver 204 may comprise any structural shape, and in one embodiment is a generally rectangular shape having a means on its distal end by which to attach a cleaning blade.

The curved blade support 202 and curved blade receiver 204 may be substantially constructed of any suitable solid or semi-solid materials, but are preferably constructed of the same materials as the handle 100 for aesthetic purposes.

The curved blade 206 comprises a cleaning blade having an attachment end and a cleaning end. The attachment end of the curved blade 206 is attached to the distal end of the curved blade receiver 204 via the means by which to attach a cleaning blade. The cleaning end of the curved blade 206 comprises a concave curvature having an arc sufficient to complement standard convex mirrors found on tractor-trailer combinations. The curved blade 206 may be substantially constructed of any suitable flexible and resilient material, but typically is constructed of a resilient material or combination of materials such that the combination is resistant to tearing and delaminating while not marring the finish on a glass mirror. As an example, and without limiting the scope of the present invention, various exemplary embodiments of the device may be substantially constructed of one or more materials of natural rubber, synthetic rubber, silicone rubber, or combinations thereof.

The figures further identify a straight blade assembly 300, which comprises a straight blade support 302, a straight blade receiver 304, and a straight blade 306. The straight blade support 302 further comprises a narrow end and a wide end. The handle 100 further comprises a first end and a second end, and the narrow end of the straight blade support 302 of the straight blade assembly 300 is attached to the second end of the handle 100. The straight blade support 302 may comprise any structural shape, and in one embodiment is a generally triangular shape having its narrow end nearest the handle 100. The triangular shape of the straight blade support 302 is advantageous in that it provides strength and bending resistance to the combination while also reducing weight, though is not the only advantageous shape that could be used.

The straight blade support 302 may further comprise a downward curve, which may be advantageous to the functioning of the device itself. The curving of the straight blade support 302 towards the lower aspect of the device may allow a user to apply sufficient pressure on the straight blade 306 against a planar surface by permitting an optimum angle to be achieved between the user's forearm and wrist, the handle 100, and the straight blade 306. The curving of the straight blade support 302 may be at any angle, or the straight blade support 302 may not be curved but may be planar or at a right angle.

The straight blade support 302 may further comprise cutouts or indentations for additional weight savings, though such weight savings are only advantageous so long as the structural rigidity of the device is maintained.

The straight blade receiver 304 further comprises a proximal end and a distal end, and is attached at its proximal end to the wide end of the straight blade support 302. The straight blade receiver 304 may comprise any structural shape, and in one embodiment is a generally rectangular shape having a means on its distal end by which to attach a cleaning blade.

The straight blade support 302 and straight blade receiver 304 may be substantially constructed of any suitable solid or semi-solid materials, but are preferably constructed of the same materials as the handle 100 for aesthetic purposes.

The straight blade 306 comprises a cleaning blade having an attachment end and a cleaning end. The attachment end of the straight blade 306 is attached to the distal end of the straight blade receiver 304 via the means by which to attach a cleaning blade. The cleaning end of the straight blade 306 comprises a flat edge to complement a planar mirror or window. The straight blade 306 may be substantially constructed of any suitable flexible and resilient material, but typically is constructed of a resilient material or combination of materials such that the combination is resistant to tearing and delaminating while not marring the finish on a glass mirror. As an example, and without limiting the scope of the present invention, various exemplary embodiments of the device may be substantially constructed of one or more materials of natural rubber, synthetic rubber, silicone rubber, or combinations thereof.

As contemplated by the present invention, in a preferred embodiment the improved double-sided convex mirror cleaning tool comprises a handle 100, a curved blade assembly 200, and a straight blade assembly 300. In a second embodiment the improved double-sided convex mirror cleaning tool may comprise only the handle 100 and the curved blade assembly 200. In a third embodiment the improved double-sided convex mirror cleaning tool may comprise the handle 100, the curved blade assembly 200, and a plurality of attachments.

Such attachments may comprise any attachments commonly found in the automotive, trucking, or window cleaning industries, and may be attached to the combination to provide additional functionality to the device. As an example, and without limiting the scope of the present invention, various exemplary embodiments of the device may comprise a broom handle attachment receiver to permit a user to extend the handle length of the combination. Another exemplary embodiment of the device may comprise an ice scraper for use in cold weather conditions, a sponge for scrubbing the glass surface, or a hand broom for cleaning an area. Another exemplary embodiment of the device may comprise a hammer or glass breaking tool to allow a user to break a window in the event of an emergency. Yet other exemplary embodiments of the device may comprise a screwdriver attachment, a pry tool, or a multi-tool. A derivative embodiment of the device may comprise a flashlight attachment with battery capacity built into the handle. Another advantageous combination may be the inclusion of a tire pressure gauge so that a user can perform such basic maintenance in combination with the cleaning of the convex mirrors.

While the invention has been described in connection with what is presently considered to be the most practical and preferred embodiments, it is to be understood that the invention is not to be limited to the disclosed embodiments, but, on the contrary, is intended to cover various modifications and equivalent arrangements included within the spirit and scope of the appended claims. Note with respect to the materials of construction, it is not desired nor intended to thereby unnecessarily limit the present invention by reason of such disclosure.

I claim:

1. A convex mirror cleaning tool, comprising:
a handle;
a curved blade assembly; and
a straight blade assembly;
wherein said handle comprises a first end and a second end;
wherein said curved blade assembly is attached to said first end of said handle; and
wherein said straight blade assembly is attached to said second end of said handle.

2. The invention of claim 1,
wherein said curved blade assembly further comprises a curved blade support, a curved blade receiver, and a curved blade;
wherein said straight blade assembly further comprises a straight blade support, a straight blade receiver, and a straight blade;
wherein said curved blade support comprises a narrow end, a wide end, and a curvature;
wherein said straight blade support comprises a narrow end, a wide end, and a curvature;
wherein said curved blade receiver comprises a proximal end and a distal end;
wherein said straight blade receiver comprises a proximal end and a distal end;
wherein said narrow end of said curved blade support is attached to said first end of said handle;
wherein said narrow end of said straight blade support is attached to said second end of said handle;
wherein said wide end of said curved blade support is attached to said proximal end of said curved blade receiver;
wherein said wide end of said straight blade support is attached to said proximal end of said straight blade receiver; and
wherein said curved blade is a concave blade suitable for contouring against a convex surface.

3. The invention of claim 2,
wherein said distal end of said curved blade receiver comprises a means for curved blade attachment;
wherein said distal end of said straight blade receiver comprises a means for straight blade attachment;
wherein said curved blade is attached to said distal end of said curved blade receiver by said means for curved blade attachment; and
wherein said straight blade is attached to said distal end of said straight blade receiver by said means for straight blade attachment.

4. The invention of claim 3,
wherein said curvature of said curved blade support orients said curved blade at an angle offset from a horizontal plane through said handle; and
wherein said curvature of said straight blade support orients said straight blade at an angle offset from a horizontal plane through said handle.

5. The invention of claim 4,
wherein said curved blade is removably attached to said distal end of said curved blade receiver by said means for curved blade attachment; and
wherein said straight blade is removably attached to said distal end of said straight blade receiver by said means for straight blade attachment.

6. A convex mirror cleaning tool, comprising:
a handle; and
a curved blade assembly;
wherein said handle comprises a first end and a second end; and
wherein said curved blade assembly is attached to said first end of said handle.

7. The invention of claim 6,
wherein said curved blade assembly further comprises a curved blade support, a curved blade receiver, and a curved blade;
wherein said curved blade support comprises a narrow end, a wide end, and a curvature;
wherein said curved blade receiver comprises a proximal end and a distal end;
wherein said narrow end of said curved blade support is attached to said first end of said handle;
wherein said wide end of said curved blade support is attached to said proximal end of said curved blade receiver; and
wherein said curved blade is a concave blade suitable for contouring against a convex surface.

8. The invention of claim 7,
wherein said distal end of said curved blade receiver comprises a means for curved blade attachment; and
wherein said curved blade is attached to said distal end of said curved blade receiver by said means for curved blade attachment.

9. The invention of claim 8,
wherein said curvature of said curved blade support orients said curved blade at an angle offset from a horizontal plane through said handle.

10. The invention of claim 9,
wherein said curved blade is removably attached to said distal end of said curved blade receiver by said means for curved blade attachment.

11. The invention of claim 10, further comprising:
an attachment assembly;
wherein said attachment assembly is attached to said second end of said handle.

12. The invention of claim 11,
wherein said attachment assembly is an ice scraper

13. The invention of claim 11,
wherein said attachment assembly is a sponge.

14. The invention of claim 11,
wherein said attachment assembly is a hand broom.

15. The invention of claim 11,
wherein said attachment assembly is a hammer.

16. The invention of claim 11,
wherein said attachment assembly is a screwdriver attachment.

17. The invention of claim 11,
wherein said attachment assembly is a pry tool.

18. The invention of claim 11,
wherein said attachment assembly is a multi-tool.

19. The invention of claim 11,
wherein said attachment assembly is a flashlight attachment.

20. The invention of claim 11,
wherein said attachment assembly is a tire pressure gauge.
